(19) United States
(12) Patent Application Publication
(10) Pub. No.: US 2012/0321806 A1
(43) Pub. Date: Dec. 20, 2012

(54) Flood Temporary Relief System and Method

(76) Inventor: Michael Gibson, Beaumont, TX (US)

(21) Appl. No.: 13/595,544

(22) Filed: Aug. 27, 2012

Related U.S. Application Data
(62) Division of application No. 11/852,388, filed on Sep. 10, 2007.

(51) Int. Cl. B05D 5/00; B05C 5/00; B05C 11/11; C08G 79/04

(52) U.S. Cl. 427/385.5; 521/129; 118/612

(57) ABSTRACT

A kit for temporarily relieving flood water seep includes a unitized enclosure with segregated containers for a prepolymer and catalyst, respectively. A mixer connected to the unitized enclosure combines the catalyst and prepolymer and a disperser connected to mixer sprays the combined catalyst and prepolymer. The prepolymer and catalyst, in contact with water, forms a pliable solid of density of at least about 7 lb./cu.ft. The kit may be a consumer article, and the polymer can be removable after flooding subsides.

### CROSS-REFERENCE TO RELATED APPLICATIONS

The present application is related to and is a divisional of U.S. patent application Ser. No. 11/852,388, titled “Flood Temporary Relief System and Method”, filed Sep. 10, 2007, of the same inventor hereof and co-pending herewith, and is incorporated herein.

### BACKGROUND OF THE INVENTION

The present invention generally relates to flood water protectors and, more particularly, relates to temporary barriers for preventing flood water from invading structures.

Conventional flood water barriers for avoiding flood damage to houses, buildings and other structures typically are permanent systems, such as permanent sealants, diverters, sieves, berms, ground trenches, French drains, infrastructure drainage configurations, and the like. Temporary systems for flood avoidance in structures has typically been merely sandbags, rolled vinyl sheets and temporary berms or troughs dug in grounds. All of these available solutions, and their uses, have been substantially permanent in nature and generally have required pre-flood condition planning and preparation.

Various grouts and sealants have been employed to fill holes, cracks, and separations to attempt to prevent water seepage. These grouts and sealants are often paste or gel that is applied into the hole or other water passage, where it is then allowed time to harden. Once hardened, a water seal is possible to prevent flood water penetration. Typically, these conventional substances are intended as permanent fixes to prevent water seep. In hardened state, removal of the hardened filling is removable only by breakage of the matter or solvent application to dissolve or disintegrate. Moreover, these hardened materials often have been quite visibly apparent in use, for example, they have had non-matching color, texture, and appearance and/or they have pronounced protrusion or require less slightly placement.

These conventional options for flood water relief have, therefore, not been well-suited to emergency use or application. Many times, flooding is unexpected and planning to prevent seepage and damage is not possible. Moreover, typical flood relief measures have disadvantages and present problems whenever only temporary flood relief is required. Conventional materials and usage often require specialized conditions, techniques, equipment, materials, safety and handling, and other aspects for application and sufficiency. If the requisite situation and other specifics are not presented, as is usually the case in emergency, then conventional alternatives are not suitable and emergency need is not met.

It would, therefore, be a significant improvement in the art and technology to provide systems, methods, compositions and other improvements for temporarily preventing flooding in structures and the like. Emergency usage solutions, in particular, would be highly desirable and advantageous.

### SUMMARY OF THE INVENTION

An embodiment of the invention is a system for temporary flood water relief. The system includes a first container for a prepolymer, a second container for a catalyst, a third container for mixing the prepolymer and the catalyst, a water source connected to the third container, for applying water to the prepolymer and the catalyst of the third container, an applicator connected to the third container, and a pressure source connected to the applicator for dispersing the prepolymer and the catalyst, as mixed, together with water, via the applicator.

Another embodiment of the invention is a kit for temporarily relieving flood water seep. The kit includes a prepolymer, a catalyst for the prepolymer, a unitized enclosure having segregated containers for each of the preploymer and the catalyst, a mixer connected to the unitized enclosure, for selectively combining the catalyst and the prepolymer in a ratio of about 1:5, and a disperser connected to the mixer for spraying combined catalyst and prepolymer from the mixer.

Yet another embodiment of the invention is a method of temporarily sealing a surface from water seepage. The method includes providing a prepolymer and a catalyst, containing the prepolymer and the catalyst, respectively, in segregated enclosures, selectively automatedly mixing the prepolymer and the catalyst, spreading the prepolymer and the catalyst from the step of mixing, and reacting the prepolymer and the catalyst to form a pliable solid polymer barrier of the step of spreading.

Another embodiment of the invention is a composition for forming a temporary water seal on a building surface in the presence of water on the surface. The composition comprises a prepolymer and a catalyst. The prepolymer consists essentially of diphylmethane diisocyanate (<10% concentration), diphenylmethane diisocyanate (<3% concentration), triethyl phosphate (<0.2% concentration), and dibutylmaleate (<45% concentration). The catalyst consists essentially of coco alkyldimethyl amines (<50% concentration) and di-isobutyl phthalate (<60% concentration).

### BRIEF DESCRIPTION OF THE DRAWINGS

The present invention is illustrated by way of example and not limitation in the accompanying figures, in which like references indicate similar elements, and in which:

FIG. 1 illustrates a temporary water barrier for a building, such as a house, the building has an outside wall and foundation with the temporary water barrier adhered to the wall and foundation, the barrier prevents flood water seepage through cracks and holes of the wall and foundation and between them, according to certain embodiments of the invention;

FIG. 2 illustrates an enlarged view of a portion of the temporary water barrier adhered to the wall and foundation of the building of FIG. 1, to prevent water seepage from flooding, according to certain embodiments of the invention;

FIG. 3 illustrates a further enlarged view of a portion of the temporary water barrier adhered to the wall and foundation of the building of FIGS. 1 and 2, and the barrier expanded and progressed into a throughway between the wall and the foundation, to prevent flood water passage the throughway, according to certain embodiments of the invention;

FIG. 4 illustrates a partial perspective view of a temporary flood relief barrier at a corner of a building, such as a house, at the juncture of respective walls and slab, the wall having certain cracks between bricks and within bricks of the wall and crevices between the wall and the foundation, according to certain embodiments of the invention;

FIG. 5 illustrates a partial perspective view of a temporary flood relief system in operation at the corner of a building, the system seals the walls and foundation of the building and between the walls and foundation, preventing flood water seepage at the corner, according to certain embodiments of the invention;

FIG. 6 illustrates a flow process of a method of temporarily sealing a surface from water seepage that is performable by a human, such as for flood relief at a house, according to certain embodiments of the invention; and

FIG. 7 illustrates an apparatus for temporarily relieving flood water seep, the apparatus is self-contained/unitized for ease of human use, such as by a homeowner, according to certain embodiments of the invention.

### DETAILED DESCRIPTION

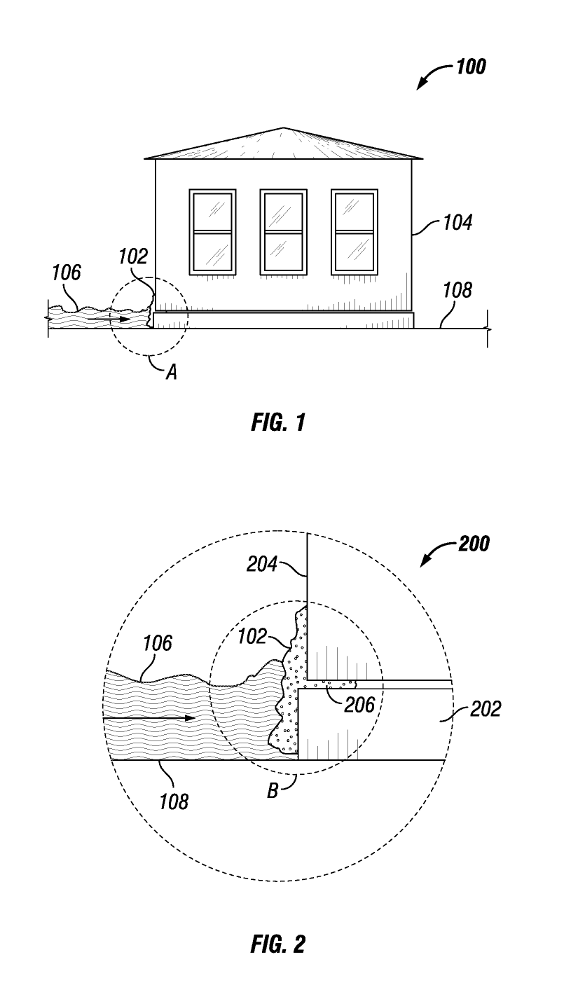

Referring to FIG. 1, a flood temporary relief system 100 includes a temporary barrier 102. The barrier 102 is applied to and adheres to a structure, such as a wall of a house 104. Flood water 106 passing or collecting atop the ground 108 adjacent the house 104 is prevented from seepage into the house 104 because of the barrier 102 on the wall of the house 104. The barrier 102 is applied to the wall of the house 104 as liquid, and the barrier 102 forms a water impermeable foam on reaction once applied. The barrier 102 is applied in locations of the wall of the house 104 (or other structure, as applicable) where flood or other water of liquid can otherwise penetrate therethrough in undesirable manner. Moreover, the barrier 102 is applicable in adverse conditions of rain, water and humidity, such as in an emergency flooding situation. The water impermeable foam of the barrier 102 on application is quickly formed and seals against water penetration, even where surfaces on which the barrier 102 is applied are wet from flooding. The barrier 102 is applicable and foam-forming in a wide variety of temperature and pressure conditions.

Referring to FIG. 2, an enlarged portion (A) of the house 104 of FIG. 1 at a baseboard corner of the house 104 includes a slab 202 and a wall 204. The slab 202 sits on the ground 108, and the wall 204 connects to the slab 204 at an edge of the slab 202. Flood water 106 resides adjacent the edge of the slab 202 and a bottom of the wall 204 at the slab 202. A water penetrable crease 206 exists where the bottom of the wall 204 meets the slab 202. The water 106 can seep, or potentially seep, through the crease 206 in absence of preventative measures. The water barrier 102, as in FIG. 1, has been applied to form the water impenetrable foam of the barrier 102 at the crease 206. As so applied, the barrier 102 has been sprayed or otherwise applied on the wall 204 and slab 202 at the crease 206. The barrier 102, applied as liquid, can penetrate some distance into the crease and also covers the edge of the slab 202 and the wall 204 (and/or portions thereof) as applied. Quickly, the liquid foams and expands, thereby becoming water impenetrable foam of the barrier 102. Adequate application to cover surfaces at the crease 206 and the crease 206, itself, forms the barrier 102 for prevention of water seepage through the crease 206.

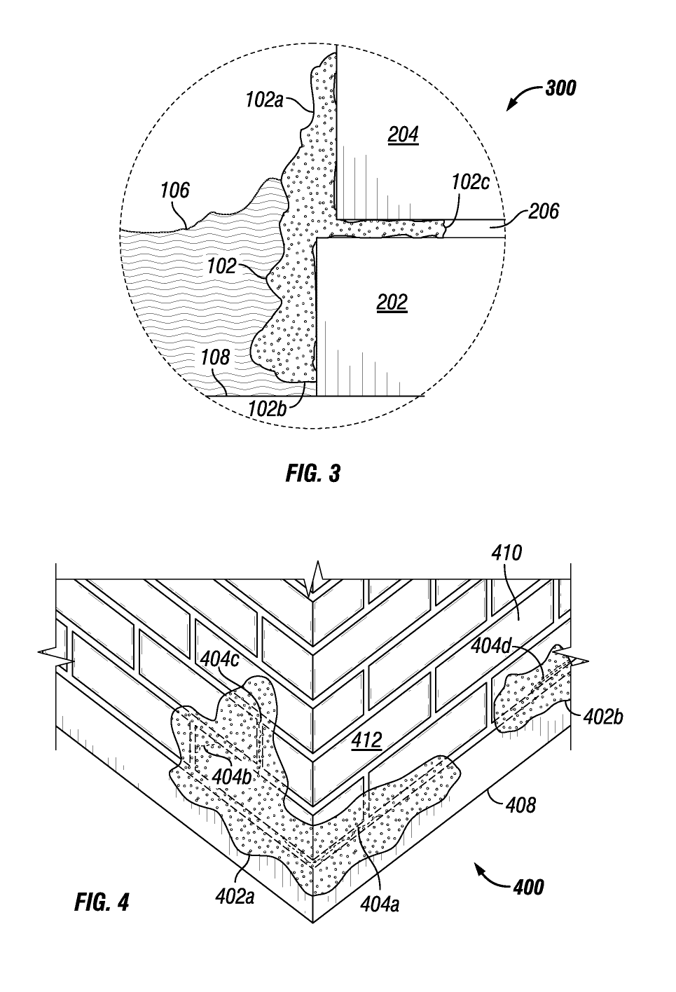

Referring to FIG. 3, a further enlarged portion (B) of the slab 202, wall 204 and attached barrier 102 of FIG. 2 includes a crease expansion portion 102c of the barrier 102 within the crease 206. On spray or other application of liquid of the barrier 102 to the vicinity of the crease 206, and the wall 204 and slab 202 thereat, the barrier 102 foams, expands and forms a pliable solid of the barrier 102. The crease expansion portion 102c is formed within the crease 206 to an extent. Adjacent the crease 206, the barrier 102 forms a wall portion 102a extending a distance along the wall 204 from the crease 206 and forms a slab portion 102b extending a distance along the edge of the slab 202 from the crease 206. The barrier 102, when so foamed, expanded and hardened to pliable solid, fills the crease 206 and surrounding surfaces sufficiently in areas of seepage (and potential seepage) of adjacent flood water 106.

Although the foregoing describes the barrier 102 as applied to prevent water seepage in event of flooding, in the house situation/environment, and in respect of the crease between the wall and slab, the barrier 102 is useful for substantially any surface or structure as temporary relief to prevent liquid or other seep or passage. Moreover, substantially any crack, opening, hole, joint, separation, passageway, or other similar narrow throughway is sealable to prevent liquid passage.

Referring to FIG. 4, a temporary flood prevention system 400 is placed at a corner of a building or similar structure 412 that has penetrable crevices 404a-d (shown in phantom). The structure 400 includes an upright surface 410, such as a wall, and an underlying pad 408, such as a slab. Water, such as flood water, or other liquid can penetrate the crevices 404a-d if not sealed. Two separate portions of barrier 402a, b cover and seal the crevices 404a-d. The crevices 404a-d are variously oriented, such as vertical (404c), horizontal (404a,d), and angled/jagged (404b). Corresponding surfaces in which the crevices 404a-d are formed differ greatly, such as between bricks, cement, wood, metal and/or other materials. Likewise, features of the crevices 404a-d and adjacent surfaces vary greatly, such as smooth, rough, porous, hard, soft, irregular, and others. The barrier 402a,b at each of the crevices 404a-d adheres to the surrounding surfaces and features and within the crevices 404a-d. Because the barrier 402a,b reactively expands in use, from liquid (as applied) to solid pliable foam (after application), the barrier 402a,b enters crevices 404a-d and surface and surround features. The barrier 402a,b prevents penetration into and through the structure 412 in locations where applied and adhering.

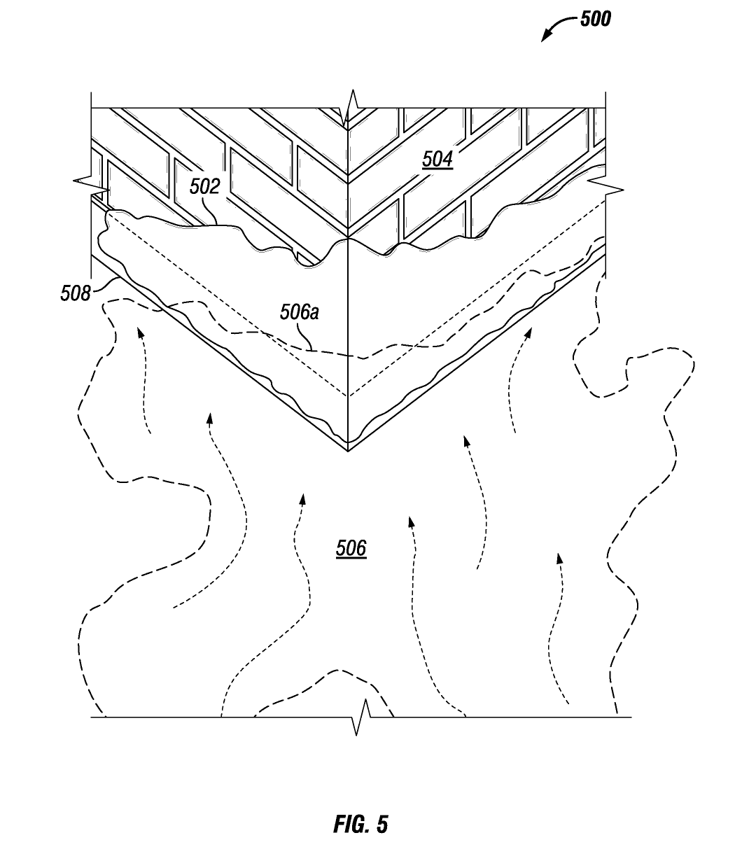

Referring to FIG. 5, a temporary system 500 for flood prevention includes a water barrier 502. The water barrier 502 is applied to and adheres in place of application to a wall 504 and a slab 508. Flood water 506 (in phantom) is adjacent to and against the wall 504 and the slab 508 at the vicinities of the water barrier 502 thereon. A surface water line 506a of the flood water 506 is at a vertical position along the water barrier 502.

In operation, liquid for the water barrier 502 is applied to the wall 504 and the slab 508 in the vicinities of FIG. 5. The liquid water barrier 502 is, for example, mixed and sprayed onto wall 504 and slab 508. Prior to application, surfaces in the vicinity for the application are cleared of extraneous matter, such as vines, foliage, and other matters that could prohibit or disturb desired coverage, adherence, and placement. After mixing and spray, the liquid foams and expands to a pliable solid, such as a polyurethane foam material. The pliable solid water barrier 502 adheres to the wall 504 and the slab 508 as so applied. The barrier 502 is hydrophobic when hardened as the pliable solid. The barrier 502 does not harm or degrade surfaces to which applied, and once hardened after application, the barrier 502 is generally non-hazardous.

After use of the barrier 502 is completed, for example, after event of flooding subsides, the barrier 502 is removable from adherence to the surfaces and porous cracks and openings. For example, the barrier 502 is removed by high pressure power washer using water, or by peeling, brushing, scraping or the like. Power wash, or other process, removes substantially all of the barrier 502 from the surfaces. The barrier 502 material remaining after removal from applied surfaces is disposed as typical household waste and does not adversely affect water potability.

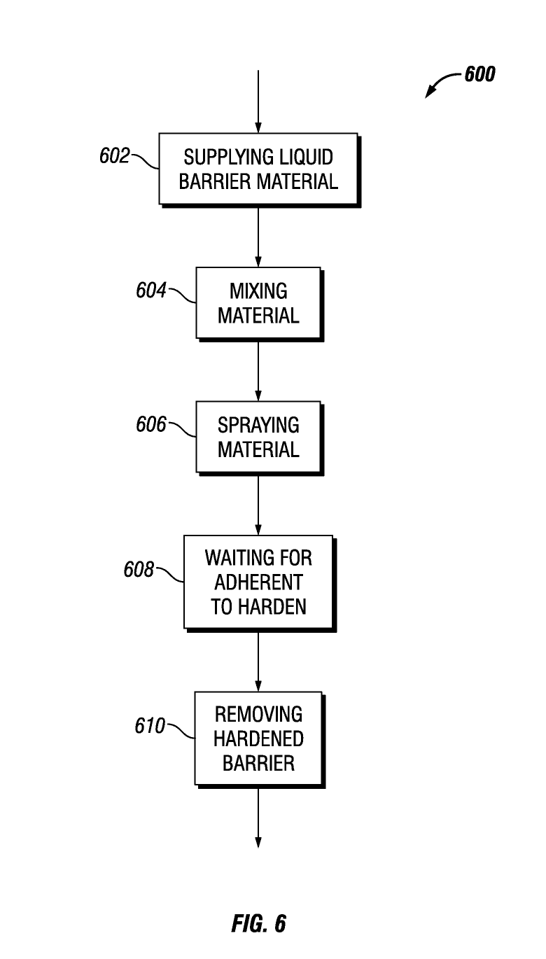

Referring to FIG. 6, a method 600 of relieving flood water seepage into a structure having an opening or crack commences in a step 602 of supplying a liquid barrier material. The liquid barrier material is supplied, for example, in a container, bucket, can or enclosure, such as metal, plastic or the like suitable for containing the material. A step 604 of mixing the liquid barrier materials follows. As later described, the liquid barrier material can comprise more than one component which must be combined in the enclosure for the materials prior to spraying in use. The mixing step 604 is performable manually, such as by hand stirring with a spoon, stick or the like, powered mechanically, such as by mixing machine, drill with stir bit, or other, or combinations.

Following the mixing 604, the method 600 continues with a step 606 of spraying or otherwise applying the mixed liquid barrier material to a surface for protection from flood penetration. The step 606 applies the liquid barrier material in a substantially continuous pattern, to a surface at and around the vicinity of a crack or opening of the surface. Because the liquid barrier material expands somewhat on hardening, the liquid barrier material must merely substantially the surfaces in a continuous and closely-spaced region. Therefore, spraying or other application in the step 606 is sufficient if closely spaced splatters either join on application to the surface or else are very close to adjacent splatters.

After the spraying step 606, a step 608 of waiting a short period of time is required for the liquid barrier material to expand and harden on the surface and areas of interest. In the step 608, the liquid barrier material reacts to form a hardened pliable foam barrier material. In the reaction, the liquid barrier material foams and expands in attachment to the surface and areas of interest. This foam and expansion effect of the barrier material allows for spray (i.e., liquid) application and surface coverage and crevice fill. Once the step 608 is complete, the foam barrier material prevents water passage. The spraying step 606 can be performed even though a surface is wetted, such as because of flood or rain water. Hardening of the barrier material does not require dry surfaces for adherence or reaction.

When flood waters subside or at otherwise desired instant, the method 600 concludes with a step 610 of removing the hardened pliable barrier material from surfaces. The barrier material provides temporary flood relief from water or other liquids. Emergency flood situations and the like require such temporary preventive measures. The step 610 is performed manually or mechanically. High pressure power wash, by means of powered pressure wash machine or the like, dislodges the barrier material from adherence to the surfaces. Manual peel or brush, scrape or other removal tools can also or additionally be employed in the step 610. After removal in the step 610, the barrier material is disposed as typical household or other general waste.

### Barrier Materials:

Materials suitable as the barrier material to provide for the foregoing temporary flood relief include a variety of liquid applicable substances that expand and harden on application to form water seals. The materials adhere to a variety of surfaces, including wood, brick, cement, metal, stucco, shingle, and others, yet are relatively easily removable from adherence after flood water sealing needs are past. Moreover, the materials harden at typical environmental temperatures and pressures, and react effectively to harden in the presence of water. The materials are also handleable by homeowners, building management, and the like, without exceptional specialized skill or precautions in handling. Further, general consumer-use, with basic household and maintenance equipment, containers, dispersion, and disposal facilities, and consumer-oriented packaging for sale and use, such as buckets, paint sprayer, wheeled container, and the like, are possible for the materials and relevant tools and equipment.

A polymer, for example, a polyurethane solution or the like, that hardens even in the presence of water but is easily removable from sealed surfaces after use, is suitable barrier material. An embodiment is a polymer with two components that foams, expands and hardens in the presence of water, yielding a pliable solid density of about 112.13 kg/cu.cm. (7 lb./cu.ft.) to about 128.15 kg/cu.cm. (8 lb./cu.ft.). The two components are a prepolymer liquid, gel or foam and a catalyst. The two components are mixed and sprayed or otherwise applied to the surface(s) for seal. The surfaces can be wet or dry. The amount of catalyst dictates reaction speed for the hardening. If the two component mixture is applied to a wet surface, then the reaction occurs. If a dry surface, the two component mixture is dispersed in water on application, such as by paint-type sprayer or other dispersal equipment.

### EXAMPLE

A polymer barrier material is available from Azon US, Inc., identified as Azo-Grout 424™ product. This product is isocyanate preploymer, comprised of diphylmethane diisocyanate (<10% concentration), diphenylmethane diisocyanate (<3% concentration), Triethyl phosphate (<0.2% concentration), and dibutylmaleate (<45% concentration). Catalyst for this product is also available from Azon US, Inc., identified as Azo-Cat 25™ product. The catalyst is comprised of coco alkyldimethyl amines (<50% concentration) and di-isobutyl phthalate (<60% concentration).

In the example, these products were obtained and mixed in a ratio of about 1:5 (catalyst:prepolymer volumes), yielding a pliable solid density on curing of about 112.13 kg/cu.cm. (7 lb./cu.ft.) to about 128.15 kg/cu.cm. (8 lb./cu.ft.). Each of the catalyst and prepolymer may have toxic fumes, therefore, the mixing was performed in an area of good ventilation. Both components could also have skin irritation effects, so gloves were worn for mixing. Mixing was performed in a paint sprayer container enclosable with a top having a connected sprayer and nozzle. A common paint sprayer container, hose, and spray gun were employed to hold the components for application on surfaces.

In certain trials with the foregoing components and assembly, a water wetted surface was coated with the mixed components of prepolymer and catalyst. Trials included coating of wood, brick, cement, metal, other surface materials, and combinations in which these different surface materials abut. Each of the surfaces included cracks or passages through which water progresses in absence of seal. Several trials were conducted in environmental temperatures of ranges on the order of 62° F. and 95° F., respectively.

The barrier material was liquid (e.g., solution/dispersion) as applied to the surfaces. Promptly on coating of the wet surfaces (in about 20 seconds), the barrier material reacted to foam, expand and harden. Expansion of the foam filled, at least in part, the cracks or other passages. Once hardened, the barrier material was a solid pliable foam that adhered to the surfaces and within the portions of cracks and passages. The mixed prepolymer:catalyst components were applied in quantities of the mixture of on the order of about 1 gal/100 sf of surface, and wide range of variation in quantities will be possible for suitable use.

Flood water seepage relief was tested by variously spraying water on and around the foam, holding-up (i.e., containing) water to a level above the cracks or passages, and otherwise simulating flood conditions against the surfaces, including, for example, water build-up and flows. The barrier material prevented water seepage and passage through the surface and its cracks and openings.

In other certain trials with the components and assembly, a dry surface was coated with the mixed components of prepolymer and catalyst. Trials included coating of the same types of surface materials and conditions. The surfaces also included various cracks or passages through which water progresses in absence of seal.

Because the surfaces were dry prior to application, a water feed was mixed with the components as they were dispersed from the paint sprayer equipment. In the arrangement, a garden hose carrying water from city utilities was connected to the spray nozzle. At the spray nozzle, the water was mixed with the components mixture and spray pressure was supplied by the water pressure.

The various surfaces, including locations of cracks and throughways of the surfaces, were coated with the liquid components mixture and water combination. The combination foamed and adhered to the surfaces as sprayed. The foam expanded as it contacted the surfaces. In a short time period (on the order of about 20 seconds), the expanded foam hardened to a pliable solid adhered to the surfaces. The hardened foam expanded to reside within and adhered within the cracks and throughways at some depth therein.

The surfaces having the barrier material were tested under simulated flood conditions. The barrier material was effective to inhibit water leakage through the surfaces.

In all trial scenarios, pressure wash with water removed the barrier material after test. Hand removal was also employed in several instances to demonstrate effectiveness. Environmental conditions were varied for certain tests. Warmer temperature and/or mixed components in solution tend to react faster than cooler analogs. However, reaction times were minimal in all instances. Moreover, varied concentrations of catalyst to prepolymer were employed, and increasing catalyst ratio from 1:5 tends to cause more speedy hardening to pliable solid once applied to surfaces.

Manufacturer instructions for prepolymer and catalyst state that each may be toxic to humans if prolonged exposure to skin, inhalation of fumes, or ingestion. The hardened pliable barrier material, however, does not present these considerations.

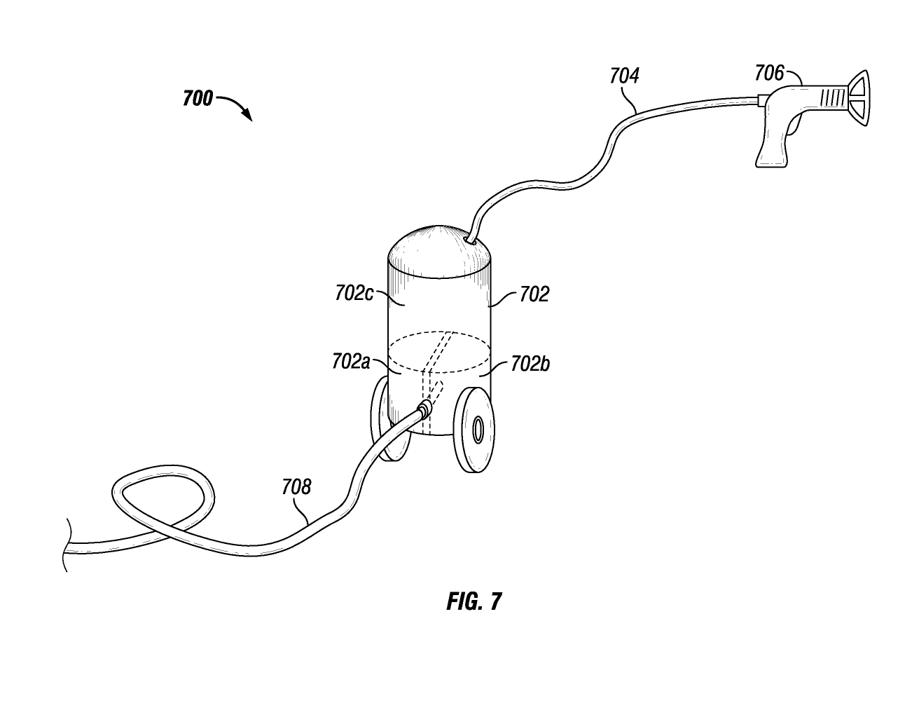

Referring to FIG. 7, a barrier applicator 700 for mixing and applying barrier material in accordance with the foregoing includes a bucket container 702. The bucket container 702 is metal, encloses the prepolymer and catalyst unmixed (ratio about 5:1), and has wheels for ease of movement in barrier application. A spray hose 704 is coupled to the container 702. A spray gun and nozzle 706 is coupled to the spray hose 704. Segregated compartments 702a,b and mix compartment 702c are formed in the container 702, in order to separate the prepolymer and catalyst in the segregated compartments 702a,b until use and mixing in the mix/dispersion compartment 702c. Internal valves respectively connect each of the segregated compartments 702a,b, and pass the prepolymer and catalyst into and out the mix/dispersion compartment 702c during application of the components to surfaces to be sealed.

The bucket container 702 is incorporated with or connected to a pressure source to selectively force the mixed components through the spray hose 704 and out the gun and nozzle 706. For example, contents of the container 702 are pressurized and trigger of the gun and nozzle 706 passes the respective prepolymer and catalyst into the mix compartment and then out the gun and nozzle 706 in dispersion on surfaces. Alternately or additionally, a pressured water source, such as through a garden hose 708 connected to a water utility supply, effects pressurization within the segregated compartments 702a,b and then to mix compartment 702c sufficient to force the mixed components and water from the source through the spray hose 704 and out the gun and nozzle 706. Water from the water spray hose 704 is concurrently, or separately, applied to desired surfaces on application of the mixed prepolymer and catalyst to trigger reaction and form barrier material. The pressurized water of the water source is dispersable on the surface by the gun through segregated nozzle (i.e., segregated from the prepolymer and catalyst mix) or otherwise separately dispersed on the surface. The water, on introduction to the prepolymer and catalyst mix, causes reaction of to form the barrier material of pliable solid density of about 112.13 kg/cu.cm. (7 lb./cu.ft.) to about 128.15 kg/cu.cm. (8 lb./cu.ft.) on the surfaces.

Variations are also possible in the delivery equipment. For example, a pressured water supply, such as from a utility connected water hose, is connected to a dual-chambered reservoir of a spray gun and nozzle. The respective prepolymer and catalyst are contained in respective reservoir chambers and mix together and with water when the gun is triggered during liquid barrier spray application.

Other alternatives and additions are possible. Dyes or other colorization compounds can be added to the liquid barrier material or pliable solid barrier material before or after application to vary color of barrier material in use. Of course, alternate or additional components, in liquid, solid, or gaseous form, can serve the use and purposes hereof and all are included. Further, applicator materials and equipment can include any of a wide variety of possibilities, including, for example, plastic, rubber, pressurized contents, other disperser configurations and types, handles or grips, and others.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and any element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed:

1. A system for temporary flood water relief, comprising:
a first container for a prepolymer;
a second container for a catalyst;
a third container for mixing the prepolymer and the catalyst; and
a water source connected to the third container, for applying water to the prepolymer and the catalyst of the third container;
an applicator connected to the third container; and
a pressure source connected to the applicator for dispersing the prepolymer and the catalyst, as mixed, together with water, via the applicator.

2. The system of claim 1, further comprising:
a surface for sealing from flood water permeation;
wherein the surface is sealed from water permeation by hardening of the prepolymer, together with the catalyst, in contact with water, from the applicator.

3. The system of claim 1, wherein the third container commingles the catalyst and the prepolymer in a ratio of about 1:5.

4. The system of claim 1, wherein the prepolymer, together with the catalyst, in contact with water, forms a closed-cell, adhering polyurethane polymer upon hardening, the polyurethane polymer having a density of at least about 112.13 kg/cu.cm. (7 lbs./cu.ft.) when hardened.

5. The system of claim 1, wherein the prepolymer and catalyst forms a polyurethane applied as liquid that foams, expands and hardens in contact with water, to pliable solid of density of about 112.13 kg/cu.cm. (7 lb./cu.ft.) to about 128.15 kg/cu.cm. (8 lb./cu.ft.) on application.

6. The system of claim 4, wherein the prepolymer consists essentially of:
diphenylmethane diisocyanate (MDI) (<10% concentration);
diphenylmethane diisocyanate (homopolymer) (<3% concentration);
triethyl phosphate (<0.2% concentration); and
dibutylmaleate (<45% concentration).

7. The system of claim 6, wherein the catalyst consists essentially of:
coco alkyldimethyl amines (<50% concentration); and
di-isobutyl phthalate (<60% concentration).

8. A system for temporarily relieving flood water seep into a narrow throughway of a surface structure exposed to flood water, the narrow throughway including any of a joint, crack, crevice, abutment, separation, hole, passage, and combinations, of the surface structure allowing water to pass through the surface structure, comprising:
a prepolymer;
a catalyst for the prepolymer;
a unitized enclosure having segregated containers each holding one of the preploymer and the catalyst, respectively;
a mixer having a first valve connected to the segregated container for the prepolymer and a second valve connected to the segregated container for the catalyst, the first valve and second valve admit the catalyst and the prepolymer, respectively, of the segregated containers to the mixer, in combination yielding a pliable solid of density of about 112.13 kg/cu.cm. (7 lb./cu.ft.) to about 128.15 kg/cu.cm. (8 lb./cu.ft.) on curing, for spraying; and
a disperser connected to the unitized enclosure, for spraying combined catalyst and prepolymer from the mixer to the surface structure at the narrow throughway where, in contact with water, the combined prepolymer and catalyst foams, expands in and on the surface structure at the narrow throughway, and cures in about 20 seconds yielding the pliable solid of density of about 112.13 kg/cu.cm. (7 lb./cu.ft.) to about 128.15 kg/cu.cm. (8 lb./cu.ft.), sufficient to temporarily bar flood water seep through the pliable solid at the narrow throughway of the surface structure during flooding and removable by any of pressurized washing, peeling, brushing, scraping, and combinations when flooding subsides.

9. The system of claim 8, wherein the mixer is formed of the unitized enclosure.

10. The system of claim 9, wherein the disperser is formed of the unitized enclosure.

11. The system of claim 8, further comprising:
a supply of water connected to the mixer, the mixer combining the water of the supply with the combined catalyst and prepolymer, and the disperser spraying the water together with the combined catalyst and prepolymer, thereby yielding the pliable solid of density of about 112.13 kg/cu.cm. (7 lb./cu.ft.) to about 128.15 kg/cu.cm. (8 lb./cu.ft.) on curing.

12. The system of claim 11, wherein the supply of water is contained by the unitized enclosure, segregated from the polymer and copolymer until combined by the mixer with the combined catalyst and prepolymer.

13. A method of temporarily sealing a surface from water seepage, comprising the steps of:
providing a prepolymer and a catalyst;
containing the prepolymer and the catalyst, respectively, in segregated enclosures;
selectively automatedly mixing the prepolymer and the catalyst;
spreading the prepolymer and the catalyst from the step of mixing; and
reacting the prepolymer and the catalyst to form a pliable solid polymer barrier of the step of spreading.

14. The method of claim 13, wherein the step of spreading comprises foaming, expanding, and hardening to obtain the polymer barrier, the polymer barrier having a density of at least about 112.13 kg/cu.cm. (7 lb./cu.ft.).

15. The method of claim 13, further comprising the step of:
combining water with the prepolymer and the catalyst immediately prior to the step of spreading.

16. The method of claim 13, wherein the step of spreading comprises the step of combining water with the prepolymer and the catalyst.

17. The method of claim 14, further comprising the step of:
removing the pliable solid polymer barrier by pressure wash with water.

18. The method of claim 13, wherein a human consumer performs the method without contacting the prepolymer and the catalyst, in segregated forms.

19. The method of claim 18, wherein the method is performed with a unitized equipment.

20. A composition for forming a temporary water seal on a building surface in the presence of water on the surface, comprising:
a prepolymer consisting essentially of:
diphenylmethane diisocyanate (MDI) (<10% concentration);
diphenylmethane diisocyanate (homopolymer) (<3% concentration);
triethyl phosphate (<0.2% concentration); and
dibutylmaleate (<45% concentration); and
a catalyst of the prepolymer consisting essentially of:
coco alkyldimethyl amines (<50% concentration);
di-isobutyl phthalate (<60% concentration); and
wherein the preploymer and catalyst, in contact with the water, hardens to a closed-cell polymer of density of at least about 112.13 kg/cu.cm. (7 lb./cu.ft.).

21. The system of claim 8, wherein the mixer is adapted to combine the prepolymer and catalyst in a ratio of about 5:1, thereby yielding, in contact with water and after curing, a closed-cell polymer of density of about 112.13 kg/cu.cm. (7 lb./cu.ft.) to about 128.15 kg/cu.cm. (8 lb./cu.ft.).
